(19) United States
(12) Patent Application Publication
(10) Pub. No.: US 2002/0138644 A1
(43) Pub. Date: Sep. 26, 2002

(54) Internet-based transaction management system

(76) Inventors: Howard Kaplan, Miami, FL (US); Rafael S. Labarta, Miami, FL (US)

Correspondence Address: GIFFORD, KRASS, GROH, SPRINKLE,, ANDERSON & CITKOWSKI, P.C., Suite 400, 280 N. Old Woodward, Birmingham, MI, 48009, US

(21) Appl. No.: 10/105,968

(22) Filed: Mar. 25, 2002

Related U.S. Application Data
(60) Provisional application No. 60/278,122, filed on Mar. 23, 2001.

(51) Int. Cl. G06F 15/16

(52) U.S. Cl. 709/232

(57) ABSTRACT

A system for enabling a party maintaining a website on the Internet to engage in e-commerce sales transactions over the Internet without creating and supporting necessary transaction software. A second Internet-based server supports the transaction software and provides customized sections for a plurality of associated websites. Each of the associated websites includes links posted on a screen which enable access to the second Internet-based server so that page generated by the second server appear to be pages maintained on the first server. Parties communicating over the Internet with either the first or the second server can engage in e-commerce transactions with the party maintaining the first server. The second server may communicate with the enterprise software of the party maintaining the first server in order to enable and record the transactions.

### RELATED APPLICATION

This application claims priority of U.S. Provisional Patent Application No. 60/278,122 filed Mar. 23, 2001, which is incorporated herein by reference.

### FIELD OF THE INVENTION

The present invention relates generally to transaction management systems and, more particularly, to a system for managing and conducting transactions involving disparate parties over a wide area network such as the Internet.

### BACKGROUND OF THE INVENTION

Public computer networks such as the Internet provide a convenient and efficient marketplace for products and services that were previously sold in more conventional marketplaces. For example, prior to the Internet, manufacturers of specialty chemicals might market their products through trade shows, catalogs, print media, advertising and the like. A potential purchaser learning of the chemical source through one of those channels might then write, phone or personally visit the manufacturer. The parties would then negotiate the terms of a sales-purchase contract. Using the Internet, a purchaser seeking suppliers of the same specialty chemical can quickly identify manufacturers of that chemical and contact them through websites maintained by the manufacturer. The websites include specifications and prices and often include programs for completing the transactions.

While such Internet marketing is a great boon to manufacturers of specialty products such as chemicals, and the use of the Internet to enable these transactions has increased in the last few years at an exponential rate, the parties offering their goods or services for sale on the Internet find that they must devote substantial effort to creating and maintaining the increasingly complex programs that support web-based transactions on the Internet. There is a clear need for a system which would minimize the information technology burden imposed on a manufacturer desiring to sell products and/or services or otherwise engage in e-commerce transactions over the Internet, yet provide these manufacturers with the sophisticated features of a modern e-commerce website.

### SUMMARY OF THE INVENTION

In accordance with the present invention, a vendor maintains a website providing the conventional information that potential purchasers expect to find, such as promotional material describing the manufacturer and its product line, a catalog of the manufacturer's products and potentially their sales prices, contact information, etc. One of the pages on the website provides some form of icon to be “clicked on” by users of the website who desire to engage in transactions with the web proprietor. In the preferred embodiment of the invention, this icon is formed as a bar running across the website screen. Clicking on this bar activates a link to a second Internet server, typically at a remote site. The second server is maintained by a provider of transaction services and preferably serves a number of vendors. The server associated with the second website maintains customized programs for each of the vendors with customized display pages. When a potential customer visiting the website of one of the vendors activates the transaction link to bring his computer into communication with the second server, that server generates a display of pages which appear to the potential customers as if they form part of and emanated from the vendor's website.

The second server contains sophisticated software enabling a wide variety of transactions such as auctions, supply contracts, requirement contracts, straight sales or the like. The screens provided to the potential customer by the second server allow the customer to enter into these transactions. The second server also has communication capability with enterprise software, including databases, supported on the servers of the respective vendors. During the course of completing a transaction it may access this enterprise software to obtain product information, inventory availability or the like. After a transaction is complete, communication may be established between the second server and the enterprise software of the vendor to provide database information relating to the particular transaction or any of the transactions conducted on behalf of the vendor. Similarly, the second server allows customer access, via the Internet, of records of transactions in which the customer has been a party.

In a preferred embodiment of the invention, a transaction management system stored on the second server involves a “three-tier” software architecture in which the first tier (referred to as the user interface, user services, presentation layer, or front end) is realized as one or more web pages linked with the vendor's own website. The second or middle tier (the process management, business services, business processes or business rules level) defines how transactions are conducted and controls access to the database by way of the web pages. The middle tier is customized to provide the service features offered by the vendor, including but not limited to, such offerings as delivery options, purchase terms and product comparisons. Depending on the vendor's requirements, the middle tier may be used to queue the desired transactions or initiate electronic data interchange transactions directly to the client's enterprise resource planning system. The third tier (database management, data services or back end) is where the data relating to transactions is stored.

Each vendor serviced by the second server is able to present its own customized web pages, which appear to a customer to be part of the vendor's website, showcasing those products and/or services that it has chosen to offer. In a preferred embodiment this customization is reflected in the configuration of the second tier. The configuration process is preferably implemented through specialized intelligent software, which enables the vendor to set the parameters and business rules by which its website will be operated. This customization includes personalizing the appearance of the web page, setting the names of the data fields that are exposed to the user, and determining the elements presented and their attributes. The software also allows the vendor to configure any other special services, such as a link which connects the transaction that is effected on the second server to the ERP system of the vendor. If so desired, the link can be configured to retrieve pertinent information from other remote systems, and this information can be provided to the user by way of the first tier presentation layer.

The typical chain of events that occurs for a customer follows a convenient path: from the vendor's web page, a potential customer locates the icon on the screen and selects the link to the host marketplace site. At this time, the vendor's customized web page is displayed from the marketplace host system. The customer can then take advantage of the various services and products available at this website, as configured for the vendor by using the custom software package. After selecting the desired products and services, the customer can proceed with the transaction, triggering the processes defined for the selected vendor, such as automatic payment transfers or the creation of appropriate records in the ERP system of the vendor and/or customer. Confirmation information may then be retrieved from the vendor's ERP system and displayed on the screen or relayed by e-mail to a predetermined mailbox.

### BRIEF DESCRIPTION OF THE DRAWINGS

Other objects, advantages and applications of the present invention will be made apparent by the following detailed description of the preferred embodiment of the invention. The description makes reference to the accompanying drawings in which:

FIG. 1 is a block diagram of the overall system illustrating the interconnection of a plurality of supplier servers to various customer computers, through a transaction server, all the units being interconnected through a public network such as the Internet;

FIG. 2 is a depiction of the various software layers contained within the transaction server of the present invention;

FIG. 3 is an illustration of a typical web page generated by the transaction server for provision to customer computers connected through one of the supplier servers; and

FIG. 4 is a schematic diagram illustrating the role of the transaction server in translating and integrating orders originating from various points in the system for provision to the enterprise resource program of a vendor.

### DETAILED DESCRIPTION OF THE PREFERRED EMBODIMENT

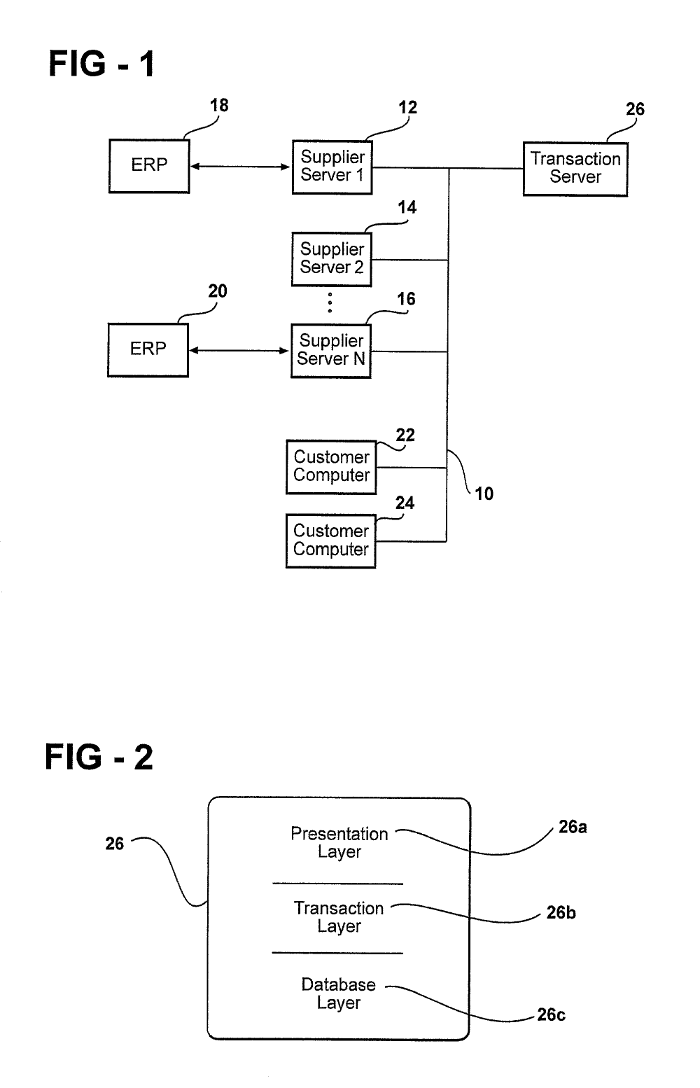

Referring to FIG. 1, the computer systems forming the system of the present invention are interconnected by the Internet 10 or some other Internet-like public network. One or more suppliers of goods and services maintain computer servers, such as 12, 14 and 16, interconnected to the Internet 10. These servers support websites of a typical nature including information about the company and the goods or services that it supplies. At least certain of these supplier servers are connected to enterprise resource processors 18 and 20 which support some or all of the computer-based functions of the corporation such as order entry, inventory and the like. Any party can typically contact one of the supplier servers 12, 14 or 16 through the Internet 10, by entering a website address or URL, in a conventional manner. Two so-called customer computers 22 and 24, typical of a large number of potential customer computers, are illustrated as being connected to the Internet 10.

When a customer computer, such as 22 or 24, addresses the website of one of the supplier servers such as 12, 14 or 16 and reviews the website and desires to place an order with the supplier maintaining such website, they will be presented with a box or icon, typically forming part of an information bar, that they can “click on” to initiate a business transaction. While the transaction is typically a sale by one of the suppliers to one of the customers, it could represent other forms of e-commerce such as an auction, an offer to sell, or the like. When the customer computer clicks on the appropriate location of the supplier's web page, a link is established to a transaction server 26 also connected to the Internet 10. This transaction server 26 is preferably maintained by a separate organization than any of those maintaining the supplier servers 12, 14 or 16 but under contract with those suppliers. Although the transaction server could operate in conjunction with only a single supplier, preferably the server 26 accommodates the needs of a number of suppliers and each of those suppliers will provide links to the transaction server 26 as part of their website.

When a customer computer 22 or 24 in contact with the website of one of the supplier servers 12, 14 or 16 clicks on the section of the website which provides the link to the transaction server 26, that transaction server will provide the particular customer computer with an additional web page that is customized for the particular supplier that the customer contacted, so that the web page, and subsequent web pages which may be addressed through this initial web page, appear to be proprietary to the particular supplier. Thus, if the transaction server 26 is affiliated with N suppliers, it will support customized programs for each of these suppliers and web pages incorporated in these customized programs will be provided to a particular customer computer that reaches the transaction server 26 from a particular supplier server.

Each of these programs will be generically similar and all are derived from a single template maintained by the company operating the transaction server 26. This template will be customized by or in cooperation with each supplier supported by the server 26. This eliminates the necessity and economic inefficiency of writing separate transaction programs for each of the suppliers. The template can preferably be customized for a particular supplier using binary choices. For example, if the supplier offers an express delivery service through UPS, Federal Express or the like, a single binary choice will indicate the availability of the service or will be eliminated from the website from the supplier which does not support that service.

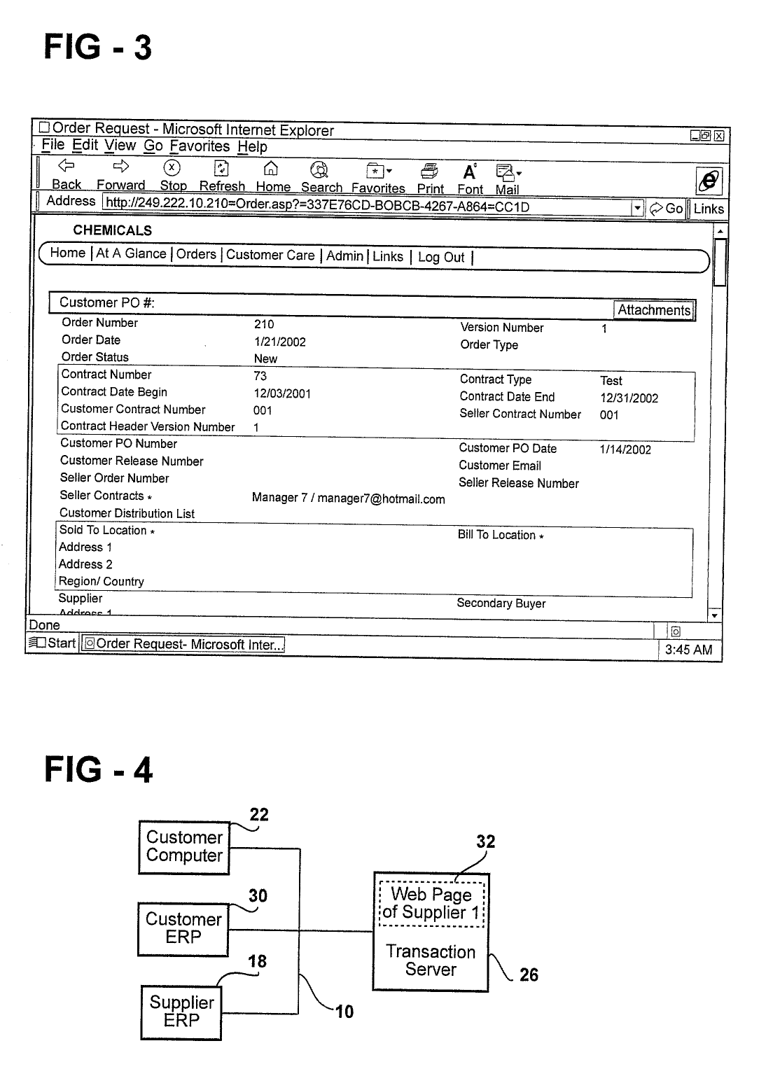

The web pages provided to a customer computer from the transaction server fully enable the completion of the desired transaction. FIG. 3 illustrates a generic web page of the type supplied by the transaction server to a customer computer desiring to enter into a transaction with one of the suppliers.

In performing the transaction, the transaction server may communicate with an ERP such as 18 or 20 of a supplier server to obtain information required to complete the transaction, such as inventory availability of a particular product from a database within the ERP. This communication is directed from the transaction server 26 through the Internet 10 and a particular supplier server 12, 14 or 16 to the ERP 18 or 20. Similar communication between the transaction server and one of the ERPs 18 or 20 can provide the ERP with information relating to a particular order, so that the order can be accepted and implemented by the supplier, the cumulative status of orders received, etc. The transaction server 26 may also be programmed to send communications, such as e-mails, to parties affiliated with the supplier to assist in completion of an order or the implementation of an order.

The structure of the software within the transaction server 26 is illustrated in FIG. 2. Essentially, the preferred embodiment of the invention utilizes a three-tiered software system of the type offered by Microsoft Corporation. The top tier, 26a, constitutes a presentation layer that supports the web page or web pages available to a customer communicating with the presentation server 26 through a particular supplier website. This layer is fully customized for a particular supplier and if the server 26 supports N suppliers, there will be N presentation layers. The next tier is a transaction layer 26b. This software level accepts the information presented through the web pages of the presentation layer 26a and implements the transaction. It may communicate with the supplier ERP during this process. This transaction layer is largely common to all of the suppliers although it may contain some customization relating to particular suppliers. The third tier of the software constitutes a database layer 26c. This layer stores information useful in completing the transaction through the layer 26b as well as information about completed transactions which may typically be accessed at any time by the ERP of a supplier or by a customer to access information about transactions in which that customer has been involved.

FIG. 4 is a variation on FIG. 1 illustrating the operation of the transaction server 26 in order entry modes. A customer 1 computer 22, a customer 2 ERP 30, and a supplier ERP 18 are all shown connected, through the Internet 10, to the transaction server 26. Customer 1 may desire, after viewing web pages provided by the supplier server and/or the transaction server 26, to place an order with a supplier 18. The purchasing agent of customer 1 may enter an order into his computer 22 which communicates with a web page of the supplier 18 within the transaction server 26. That order is stored in the database layer 26c of the transaction server 26. Similarly, a customer 2 may provide an order through that customer's ERP 30 which is provided to the transaction server 26 through the Internet. The transaction server acts to translate both orders into a common format and aggregate them for provision to the supplier ERP 18 at a common time, such as once a day. Thus, the supplier ERP 18 is relieved of the burden of analyzing orders received in different formats and acting upon them. It receives an order, or multiplicity of orders, in a single format, from the transaction server 26. Again, the transaction server 26 relieves the suppliers from independently developing software to deal with orders received in a variety of formats.

The system as heretofore described provides a service to suppliers that relieves them of the need for performing the relatively high technology tasks of developing and supporting customized transaction software and of incorporating new features in the software as the market matures. The supplier need only create a website and a link to the transaction server 26 in order to engage in a sophisticated level of e-commerce.

Having thus disclosed our invention, we claim:

1. A system for providing transaction services to a party maintaining a first website on a first Internet-based server, comprising:
a second Internet-based server maintaining transaction protocols; and
links posted on a screen of the first website enabling a party accessing the first website via a first computer connected to the Internet to access said second Internet-based server and engage in transactions enabled by said second server based on said protocols with said party maintaining said first website.

2. The system of claim 1 wherein the transaction services relate to the sale of goods and/or services of said party maintaining said first website to the third party.

3. The system of claim 2 including a plurality of parties each maintaining a website on an Internet-based server and each of said servers containing links posted on a screen of the website associated with said server enabling a party in communication with one of said websites to access said second Internet-based server and engage in transactions enabled by said circuit based on said protocols with third party computers through the Internet.

4. The system of claim 3 wherein said second Internet-based server maintains a plurality of programs, one associated with each of the websites which contain links enabling access to said second Internet-based server, each of the sections being customized for the transactions to be engaged in through the particular first server.

5. A system for providing transaction services to a plurality of first parties, each of which maintains a first website on a first Internet-based server comprising:
a second Internet-based server maintaining transaction protocols and a plurality of programs, each associated with a particular one of said first websites, each of said programs including means for generating screens relating to transactions with the party maintaining the associated first website; and
links posted on at least one screen of each of said first websites enabling a party accessing that first website via a first computer connected to the Internet, to access said second Internet-based server and engage in transactions with the party maintaining said selected first website.

6. The system of claim 5 wherein transactions comprise the sale of goods or services by said party maintaining one of said first websites with a party accessing the first website via a first computer connected to the Internet.

7. The system of claim 6 wherein at least certain of said first parties maintain enterprise computer systems and wherein said second Internet-based server can establish communication with the enterprise computer system of a particular first website to enable a transaction with the party maintaining such first website.

8. The system of claim 5 wherein said second Internet-based server can establish communication between one of said first Internet-based servers and said first computer connected to the Internet.

9. The system of claim 5 further including a second website on the Internet maintained by said second Internet-based server and means for enabling transactions between parties on the Internet accessing said second website and one of said first parties.

10. The system of claim 9 wherein access to said second website by one of said first computers is controlled by passwords provided to the first computer by one of said parties maintaining a first website.
